(19) United States
(12) Patent Application Publication
(10) Pub. No.: US 2007/0257555 A1
(43) Pub. Date: Nov. 8, 2007

(54) WIRING HARNESS

(75) Inventors: Oliver A. Bell, Aiken, SC (US); Michael J. Hebert, Evans, GA (US); Aric Singletary, Hephzibah, GA (US); Warren Clark, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/381,670

(22) Filed: May 4, 2006

(51) Int. Cl. H02G 3/00

(52) U.S. Cl. 307/9.1

(57) ABSTRACT

A vehicle wiring harness for a lightweight utility vehicle is provided. The wiring harness comprises a plurality of vehicle function components integrally connected to a plurality of branch wires. Thus, the wiring harness is fabricated to form a unitary wiring harness that includes the function components.

### FIELD

The present disclosure relates to a wiring harness for a utility vehicle.

### BACKGROUND

Known wiring harnesses for lightweight utility vehicles, such as maintenance vehicles, shuttle vehicles and golf cars, generally include various wire leads that must be connected to a plurality of small electrical components during assembly of the vehicle. Typically, the wiring harness leads are connected to the electrical components using various types of connective means, such as solder terminals, ring lugs and nuts, bolts/screws and threaded receptacles, crimp on connectors and push-on connectors. Such connective means are often subject to twisting, bending and/or breaking. Additionally, if such connective means are disconnected, the reconnections are often improper, not as tight or not as secure, leading to failure of the connection and/or failure of the respective component. Furthermore, often the wiring harness must be connected to electrical components that have been installed in the vehicle prior to connection to the wiring harness. In such cases, the connections may need to be made in areas that are difficult to see and/or access, resulting in improper or loose connections. This also, can lead to failure of the connection and/or failure of the respective component.

Generally, such connective means are often not insulated and/or sealed to protect against exposure to corrosive substances, e.g., water and dirt, and may require additional parts or installation processes to provide insulation and/or sealing. Thus, such known connective means can be costly, cumbersome, time consuming to install, subject to failure and subject to twisting, bending and/or breaking.

### SUMMARY

In various embodiments, a vehicle wiring harness for a lightweight utility vehicle is provided. The wiring harness comprises a plurality of vehicle function components integrally connected to a plurality of branch wires. Thus, the wiring harness is fabricated to form a unitary wiring harness that includes the function components.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a light-weight utility vehicle including a unitary wiring harness fabricated to include a plurality of integrally connected vehicle function components, in accordance with various embodiments of the present disclosure;

FIG. 2 is an illustration of an exemplary unitary wiring harness shown in FIG. 1, in accordance with various embodiments of the present disclosure;

FIG. 3 is an isometric view of an exemplary function component integrally connected to branch wires of the unitary wiring harness, shown in FIG. 2, in accordance with various embodiments of the present disclosure;

FIG. 4 is an isometric view of an exemplary function component integrally connected to branch wires of the unitary wiring harness, shown in FIG. 2, in accordance with various other embodiments of the present disclosure; and

FIG. 5 is an isometric view of an exemplary function component integrally connected to branch wires of the unitary wiring harness, shown in FIG. 2, in accordance with still other embodiments of the present disclosure.

### DETAILED DESCRIPTION

The following description of various embodiments is merely exemplary in nature and is in no way intended to limit the present teachings, application, or uses.

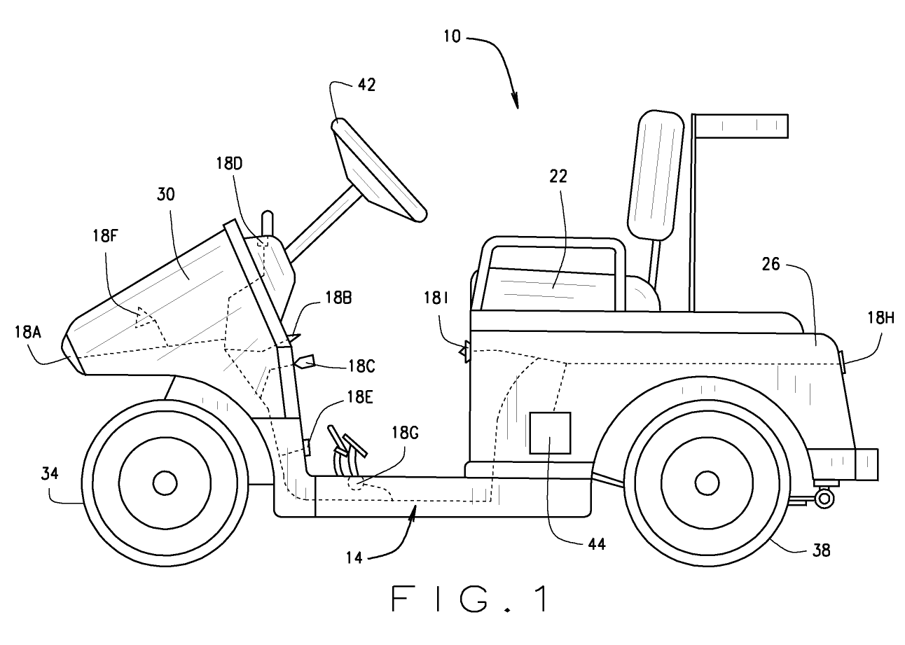

FIG. 1 illustrates a light-weight utility vehicle 10, such as a small cargo/maintenance vehicle, a shuttle vehicle or a golf car, that includes a unitary wiring harness 14 fabricated to include a plurality of integrally connected vehicle function components 18, in accordance with various embodiments of the present disclosure. The integrally connected function components 18 can comprise such things as solenoids, buzzers, switches, sensors, meters, fuse boxes, light sockets and controllers. The function components 18 can be electrical components, optical components or any other type of component that requires direct connection to a signal or power source 44, e.g., a laser engine, one or more LEDs or a battery. In various exemplary embodiments, the function components 18 can comprise a head light socket and switch 18A and 18B, an ignition key switch 18C and an instrumental panel multiplex connector 18D, a horn switch and horn 18E and 18F, a brake sensor and brake light socket 18G and 18H and a forward/reverse shifter 18I. In some implementations, the unitary wiring harness 14 can comprise the plurality of function components, wherein at least two of the plurality of function components 18 are different types of function components having different functionality.

The vehicle 10 also generally includes a seat assembly 22 mounted to a rear body section 26, a front body section 30 and a pair of front wheels 34 that operate to steer the vehicle 10. Additionally, the vehicle 10 generally includes a pair of rear wheels 38, wherein at least one of the rear wheels 38 functions as a drive wheel for propelling vehicle 10, and a steering wheel 42 used to control a steering angle of the front wheels 34.

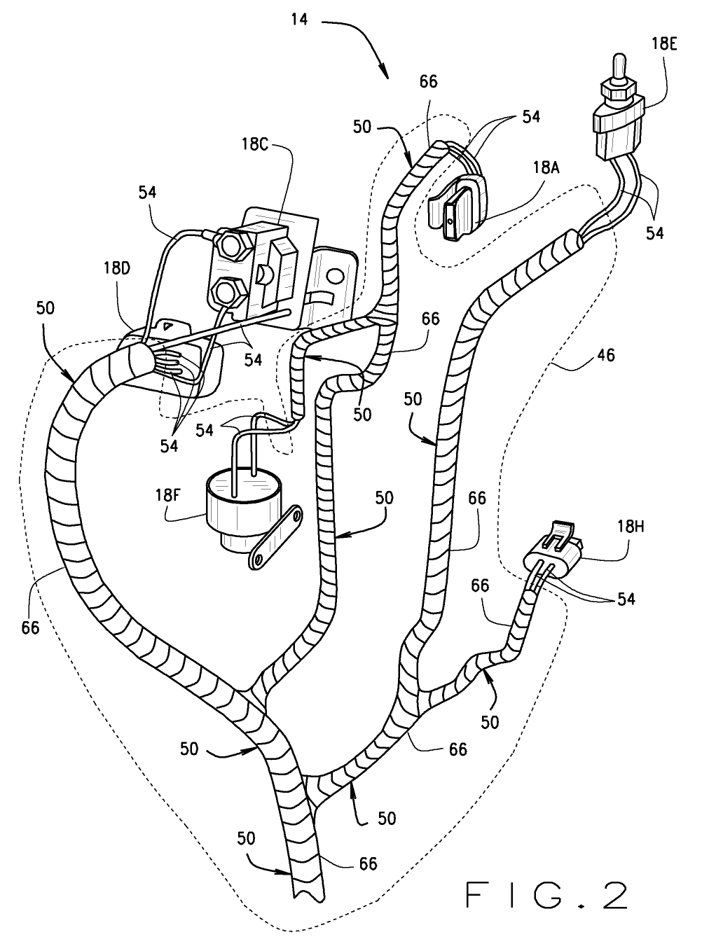

Referring now to FIGS. 1 and 2, the unitary wiring harness 14 can comprises a branch portion 46 that includes a plurality of interconnected branches 50. Each branch comprises at least one branch wire 54 that can be any suitable signal transmitting medium. For example, the branch wires 54 can be optical fibers for transmitting optical signals or electrical wires suitable for carrying electrical current and/or digital signals. The function components 18 are integrally connected to the branch wires 54 to form a unitary wiring harness that includes the branch wires 54 and the function components 18. More specifically, the unitary wiring harness 14 is fabricated to have the function components 18 connected to the branch wires 54 in an integral fashion. That is, the connection between the branch wires 54 and the function components 18 is a substantially permanent connection, or an effectively non-disconnectable connection. For example, in various embodiments the function components can be ultrasonically welded to the branch wires 54. Or, in various other embodiments the function components can be soldered to the branch wires 54.

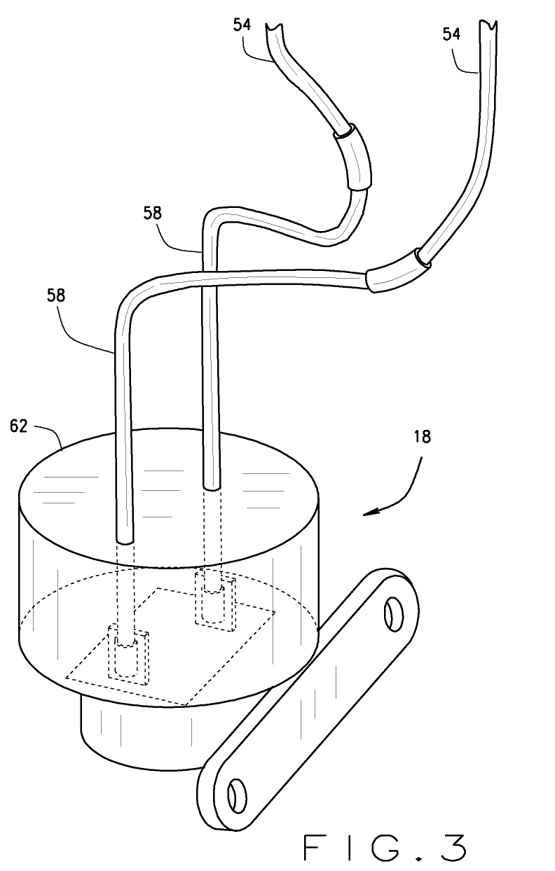

Referring to FIG. 3, in various other embodiments, one or more of the function components 18 can comprise integrally formed pigtail leads 58 extending from a body 62 of the respective function component 18. During fabrication of the unitary wiring harness 14 the branch wires 54 are integrally connected to the pigtail leads 58, thereby creating the wiring harness 14 fabricated to include the function components 18 as an integral part of the harness 14.

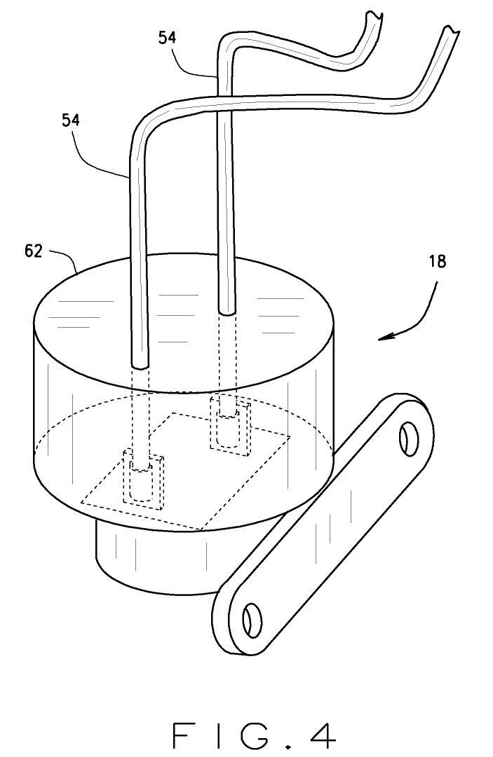

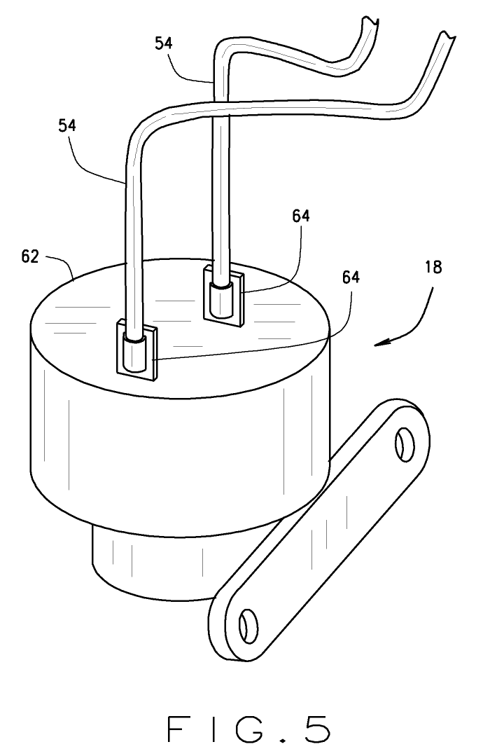

Referring now to FIGS. 4 and 5, in some implementations the branch wires 54 can be internally integrally connected to one or more of the function components 18, as shown in FIG. 4. That is, the unitary wiring harness 14 is fabricated such that the branch wires 54 are integrally connected inside of one or more of the function components 18. Alternatively, as shown in FIG. 5, in some implementations the branch wires 54 can be externally integrally connected to one or more of the function components 18. For example, the branch wires 54 can be integrally connected to external posts or tabs 64 of one or more of the function components 18.

Referring now to FIGS. 2, 3, 4 and 5, it should be understood that the unitary wiring harness 14 can comprise the function components 18 integrally connected to the branch wires 54 via any combination of integral connections. For example, one or more function components can comprise the integral pigtail leads 58 that are integrally connected to the branch wires 54, while one or more other function components of the unitary wiring harness 14 are integrally connected to the branch wires 54, as described above in reference to FIGS. 4 and/or 5. Furthermore, by integrally connecting the function components 18 to the branch wires 54, the connections are effectively insulated and/or sealed to protect against exposure to corrosive substances, e.g., water and dirt that may damage or destroy the connection.

Referring again to FIG. 2, in some embodiments, each branch 50 can comprise a flexible conduit 66 enclosing at least a portion of at least one branch wire 54. The flexible conduits 66 bundle and protect the branch wires enclosed within the respective conduit 66. The flexible conduit can comprise any suitable type of flexible conduit; for example, spiral wrap conduit, accordion ribbed conduit and/or flexible sleeve conduit. It should be understood that the various branches 50 can be of varying length and size. Similarly, the branch wires can be of varying size, gauge and/or insulators. In various embodiments, each flexible conduit 66 encloses all but a distal portion of the respective branch wire(s) 54, leaving the distal portion extending past a distal end of each respective flexible conduit 66. The distal ends portion of the branch wires are integrally connected to the respective function component 18 or the integral pigtail leads 58 of the respective function component 18, as described above.

Thus, the unitary wiring harness 14 is fabricated to include the integrally connected function components 18 to provide a unitary wiring harness that is easy to install. The unitary wiring harness 14 also eliminates the need to connect a stand-alone wiring harness to separate independent function components, during assembly of the vehicle 10, using solder terminals, ring lugs and nuts, bolts/screws and threaded receptacles, crimp on connectors and push-on connectors. Furthermore, the potential for twisting, bending and/or breaking of such solder terminals, ring lugs and nuts, bolts/screws and threaded receptacles, crimp on connectors and push-on connectors is eliminated.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A wiring harness for a lightweight utility vehicle, said wiring harness comprising a plurality of vehicle function components integrally connected to a plurality of branch wires to form a unitary wiring harness that includes the vehicle function components.

2. The wiring of claim 1, wherein the function components are ultrasonically welded to the branch wires.

3. The wiring of claim 1, wherein the function components are soldered to the branch wires.

4. The wiring harness of claim 1, wherein the function components comprise at least two different types of function components having different functionality.

5. The wiring harness of claim 1, wherein the wiring harness further comprises a plurality of interconnected branches, each branch comprising at least one branch wire.

6. The wiring harness of claim 5, wherein each function component comprises at least one integral pigtail lead integrally connected to at least one of the branch wires.

7. The wiring of claim 6, wherein the pigtail leads are ultrasonically welded to the branch wires.

8. The wiring of claim 6, wherein the pigtail leads are soldered to the branch wires.

9. The wiring harness of claim 1, wherein the wiring harness further comprises a plurality of branches, each branch comprising a flexible conduit enclosing at least a portion of at least one branch wire.

10. A method of fabricating a vehicle wiring harness for a lightweight utility vehicle, said method comprising integrally connecting a plurality of function components to a plurality of branch wires to form a unitary wiring harness fabricated to include the function components.

11. The method of claim 10, wherein integrally connecting the plurality of function components comprises ultrasonically welding the function components to the branch wires.

12. The method of claim 10, wherein integrally connecting the plurality of function components comprises soldering the function components to the branch wires.

13. A vehicle wiring harness for a lightweight utility vehicle, said system comprising:
a branch portion comprising a plurality of branches, each branch comprising at least one branch wire; and
a plurality of vehicle function components, each function component comprising at least one integral pigtail lead integrally connected to at least one of the branch wires to form a unitary wiring harness.

14. The wiring harness of claim 13, wherein at least two of the function components comprise different types of function components having different functionality.

15. The wiring harness of claim 13, wherein the pigtail leads are ultrasonically welded to the branch wires.

16. The wiring harness of claim 13, wherein the pigtail leads are soldered to the branch wires.

17. A lightweight utility vehicle comprising:
a vehicle wiring harness for a lightweight utility vehicle, said system comprising:
a branch portion comprising a plurality of branches, each branch comprising a flexible conduit enclosing a portion of at least one branch wire; and
a plurality of vehicle function components, each function component integrally connected to at least one of the branch wires to form a unitary wiring harness.

18. The vehicle of claim 17, wherein at least two of the function components comprise different types of function components having different functionality.

19. The vehicle of claim 17, wherein the pigtail leads are ultrasonically welded to the branch wires.

20. The vehicle of claim 17, wherein the pigtail leads are soldered to the branch wires.

21. The vehicle of claim 17, wherein each function component comprises at least one integral pigtail lead integrally connected to at least one of the branch wires to form the unitary wiring harness.
